(19) United States
(12) Patent Application Publication
(10) Pub. No.: US 2009/0051227 A1
(43) Pub. Date: Feb. 26, 2009

(54) LINEAR MOTOR

(76) Inventors: Houng Joong Kim, Mito (JP); Hitoshi Shibata, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/280,046

(22) PCT Filed: Mar. 31, 2006
(86) PCT No.: PCT/JP2006/307382

§ 371 Date: Aug. 20, 2008

(51) Int. Cl. H02K 41/02

(52) U.S. Cl. 310/12

(57) ABSTRACT

In prior art linear motor, a large burden is applied to a mechanism for supporting a moving member because a magnetic attracting force acts in one direction between armature and moving member and the structure is distorted to cause various troubles. In an inventive linear motor, a stator having an armature winding and a moving member having permanent magnets are arranged to be moved relatively. The stator of the linear motor includes a ring-shaped core, armature teeth and the armature winding to form a magnetic circuit. Slit grooves are formed in armature teeth opposed to both of front and rear surfaces of the permanent magnets of the moving member with an air gap defined between the stator and the moving member. A member holding the plurality of permanent magnets has holes for allowing a medium to enter or exit.

### TECHNICAL FIELD

The present invention relates to linear motors and more particularly to a linear motor which includes a primary side member having a ring-shaped core, armature teeth and an armature winding which form a magnetic circuit, and also includes a secondary side member of a permanent magnet which is reciprocatably driven through an air gap in part of the ring-shaped core.

### BACKGROUND ART

Major ones of prior art linear motors have a structure that rotary machine is cut and linearly developed and includes a stator having an armature winding and a moving member movably supported with an air gap spaced from the stator. Thus, a large magnetic attracting force takes place between the stator and the moving member, a large burden is applied to a support mechanism for keeping the air gap constant, and the overall size of the machine becomes large. In addition, the support mechanism for keeping the air gap constant with use of a gas or a liquid has a complicated structure.

In the prior art, further, a plurality of coils are wound around a single stator unit and different coils are wound around adjacent stator magnetic poles, thus resulting in that the entire structure of the machine becomes complicated.

In order to solve the above defects in the prior art, an object of the present invention is to provide a linear motor which can cancel a magnetic attracting force taking place between a stator and a moving member with a compact structure and can have a member as a permanent magnet having a high rigidity with a magnetic circuit characteristic kept. Another object of the invention is to provide a support mechanism for keeping an air gap constant with use of a gas or a liquid.

A patent document relating to the prior art linear motor is International Patent Publication WO00/69051.

### DISCLOSURE OF THE INVENTION

In accordance with the present invention, the above objects are attained by providing a linear motor which includes a plurality of permanent magnets arranged along an advancing direction and a core opposed to both of front and rear surfaces of the permanent magnets to form a closed magnetic circuit. In the linear motor, a slit groove is formed in each of armature teeth of the core, a projected (protruded) member movable along the slit groove is provided, and a member having the plurality of permanent magnets has holes for allowing a medium to enter or exit.

In accordance with the present invention, the above objects are also attained by providing a linear motor which includes a plurality of magnetic materials arranged along a proceeding direction and a core opposed to both of front and rear surfaces of the magnetic materials to form a closed magnetic circuit. A member holding the plurality of permanent magnets has holes for allowing a medium to enter or exit.

### BRIEF DESCRIPTION OF DRAWINGS

FIG. 1 shows a conceptional view of a moving member in a linear motor in accordance with an embodiment of the present invention;

FIG. 2 is a basic arrangement of a linear motor of an embodiment of the present invention;

FIG. 3 shows a moving member in a linear motor of an embodiment of the present invention;

FIG. 4 shows diagrams for explaining comparison between the moving member of the linear motor of the embodiment of the present invention and a moving member of a linear motor of a prior art;

FIG. 5 shows a first diagram for explaining how to assemble a moving member in a linear motor in accordance with another embodiment of the present invention;

FIG. 6 shows a second diagram for explaining how to assemble a moving member in a linear motor in accordance with another embodiment of the invention;

FIG. 7 shows a third diagram for explaining how to assemble a moving member in a linear motor in accordance with another embodiment of the invention;

FIG. 8 shows a fourth diagram for explaining how to assemble a moving member in a linear motor in accordance with another embodiment of the invention;

FIG. 9 shows a fifth diagram for explaining how to assemble a moving member in a linear motor in accordance with another embodiment of the invention;

FIG. 10 shows a first diagram for explaining how to assemble a moving member in a linear motor in accordance with another embodiment of the invention;

FIG. 11 shows a second diagram for explaining how to assemble a moving member in a linear motor in accordance with another embodiment of the invention;

FIG. 12 shows an arrangement of a servo control system using the linear motor of the present invention; and

FIG. 13 shows a moving member in a linear motor in accordance with another embodiment of the present invention.

### BEST MODE FOR CARRYING OUT THE INVENTION

Explanation will be made as to embodiments of the present invention with reference to the attached drawings. In the drawings, constituent elements having the same or equivalent functions are denoted by the same reference numerals or symbols.

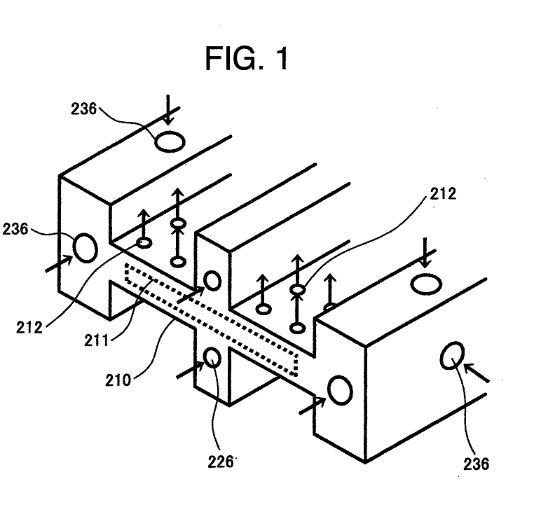

FIG. 1 shows a conceptional view of a moving member of a linear motor in accordance with an embodiment of the present invention.

In FIG. 1, a moving member 210 has permanent magnets 211 arranged along its longitudinal direction at the middle thereof, and also has holes 236 or holes 226 and holes 212 formed therein for allowing a medium to enter the holes 226 and to exit the holes 212 formed in the surfaces of the permanent magnets 211. A gas, a liquid or the like is used as the medium. Even as a method of supporting the moving member 210, a non-contact supporting method based on aero static bearing, hydrostatic bearing or the like may be employed; or a method of supporting the moving member with use of a plane slider, linear guide rails or the like may be employed.

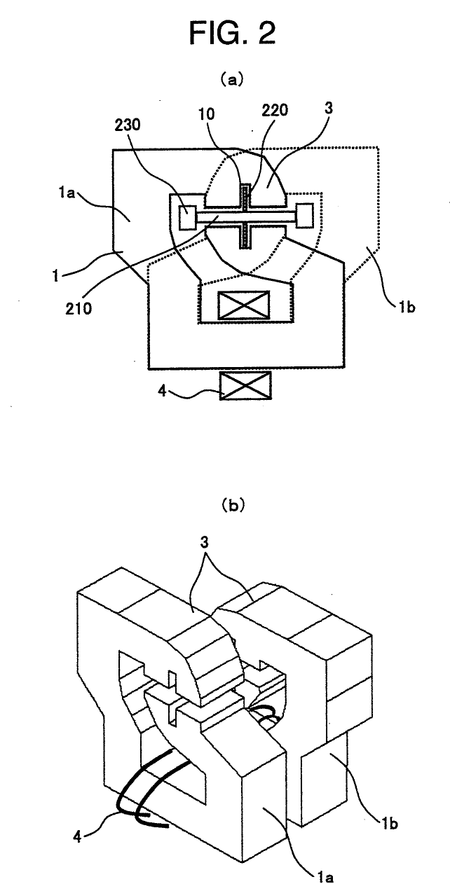

FIG. 2 shows a basic arrangement of the linear motor in accordance with the embodiment of the present invention.

In FIG. 2, the linear motor is formed to have a stator as a primary side member having an armature winding 4 and the moving member 210 as a secondary side member which has permanent magnets and which is relatively movable thereto. The structure or contents of the linear motor is the same as those of the linear motor shown in International Patent Publication WO00/69051, unless otherwise specifically noted.

The linear motor is featured in that the stator of the linear motor includes a ring-shaped core 1, armature teeth 3, and the armature winding 4, which form a magnetic circuit, the ring-shaped core 1 is provided partially with the armature teeth 3 which are opposed to both of front and rear surfaces of the permanent magnets of the moving member with an air gap defined therebetween, a slit groove 10 is formed in each of the armature teeth 3, and a projected member 220 slidable along the slit grooves 10 of the armature teeth 3 is provided on the surfaces of the permanent magnets.

It is also possible that the ring-shaped core is provided partially with the armature teeth 3 which are opposed to both of the front and rear surfaces of the permanent magnets of the moving member 210 with the air gap defined therebetween, guide rails 230 are provided along the longitudinal direction of the moving member, and a support mechanism (not shown) is located at the side of the ring-shaped core 1 in association with the guide rails 230.

FIG. 2 schematically shows the arrangement of the common armature winding 4 to an odd-numbered ring-shaped core 1a and an even-numbered ring-shaped core 1b. In FIG. 2(b), only two of the ring-shaped cores are illustrated. However, even when two or more of the odd-numbered ring-shaped cores and two or more of the even-numbered ring-shaped cores are provided, they may be arranged with use of the single armature winding 4.

With such an arrangement, magnetic fields in opposed directions can be established between the magnetic poles of the adjacent cores by causing a current to flow through the single armature winding.

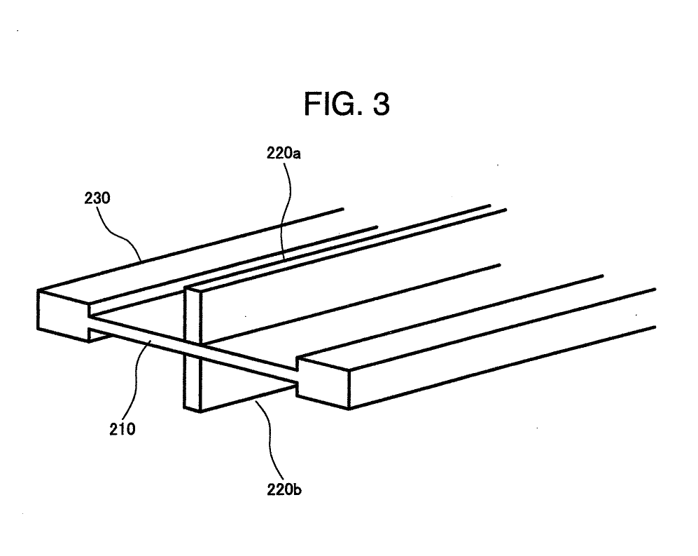

FIG. 3 shows a moving member in a linear motor in accordance with an embodiment of the present invention.

In FIG. 3, projected members 220a and 220b are provided on the front and rear surfaces of the moving member 210 at its middle part, and the guide rails 230 are provided at both sides of the moving member 210 along its longitudinal direction. Of course, it is possible to form holes in the moving member to allow such a medium as shown in FIG. 1 to enter or exit the holes.

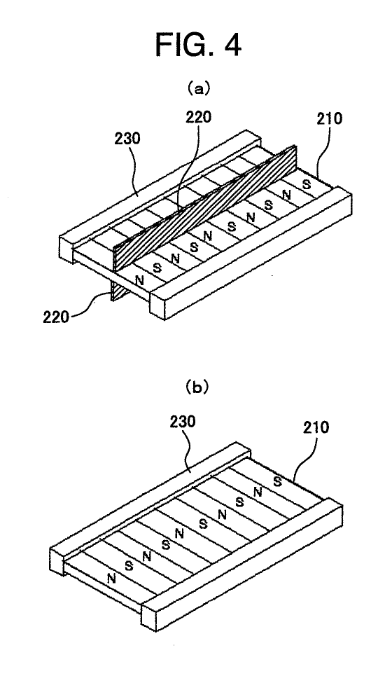

FIG. 4 shows the moving member in the linear motor in accordance with the embodiment of the present invention and a moving member in a prior art linear motor for comparison therebetween.

FIG. 4(a) show the moving member in the linear motor of the present invention having the projected members 220 provided on the front and rear surfaces of the moving member 210 at its middle part, and FIG. 4(b) shows the moving member in the prior art linear motor not provided at its middle part on the front and rear surfaces of the moving member 210. In FIG. 4(a), since the projected members 220 are provided on the front and rear surfaces of the moving member 210 at its middle part, the moving member can have a large sectional moment of the second order (moment of inertia of area) and can advantageously have a strong rigidity.

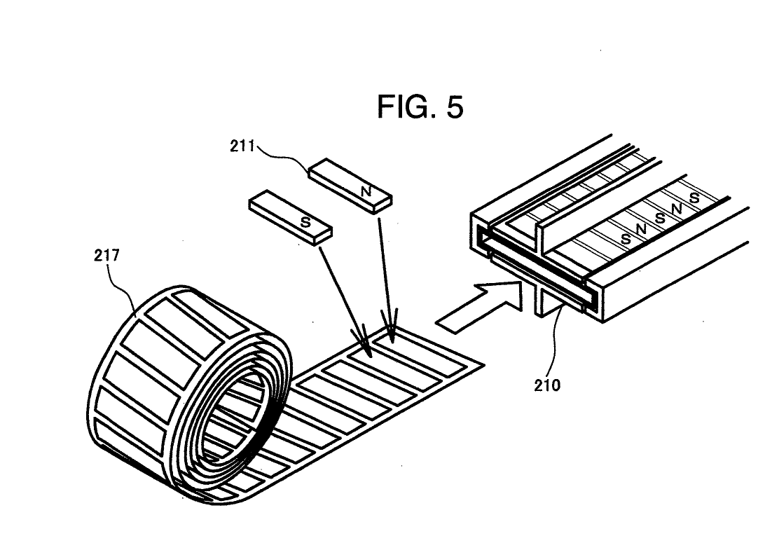

FIG. 5 shows an example of how to assemble the moving member in the linear motor of the present invention.

The permanent magnets 211 can be fitted in the moving member having hollows by inserting a third member 217 having the permanent magnets 211 of N, S, N, S, and so on arranged in this order with a predetermined spacing therebetween into the hollowed moving member. Of course, it is possible to form such holes in the hollowed moving member as to allow such a medium as shown in FIG. 1 to enter or exit the holes.

In the permanent magnets 211 of the linear motor of the present invention, when the permanent magnets are skewed, a variation in the predetermined interval between the N and S poles may also allow the shape of the permanent magnet to have a shape other than a rectangle.

There may also be possible such a linear motor that the permanent magnets 211 of the moving member 210 in the linear motor of the present invention is replaced with ferroelectric materials, or may also possible such a linear motor of a structure of the permanent magnets and the ferroelectric materials in combination. Further, there may be possible such a linear motor that the permanent magnets are replaced with electromagnets having a core coil, or electromagnets having coils wound around ferroelectric materials are arranged to have N, S, N, S polarities and so on in this order.

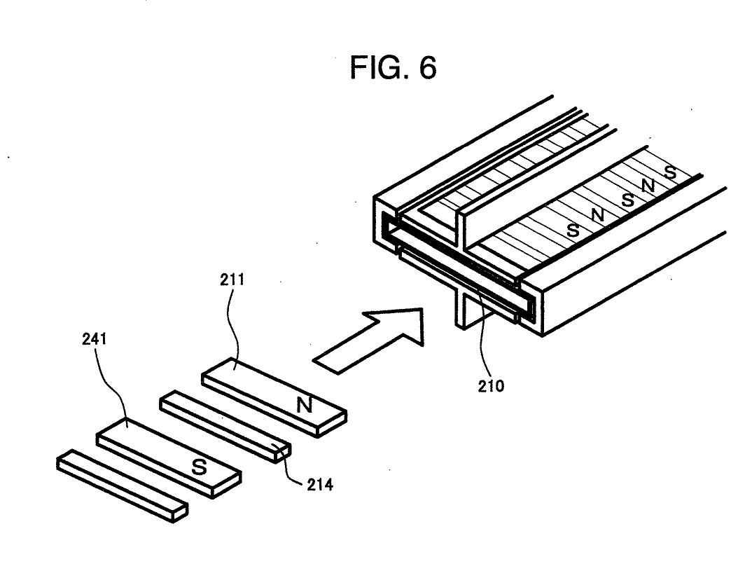

FIG. 6 shows an example of how to assemble a moving member when the third member 217 for spacing permanent magnets 241 by a constant distance therebetween is replaced with a spacer 214.

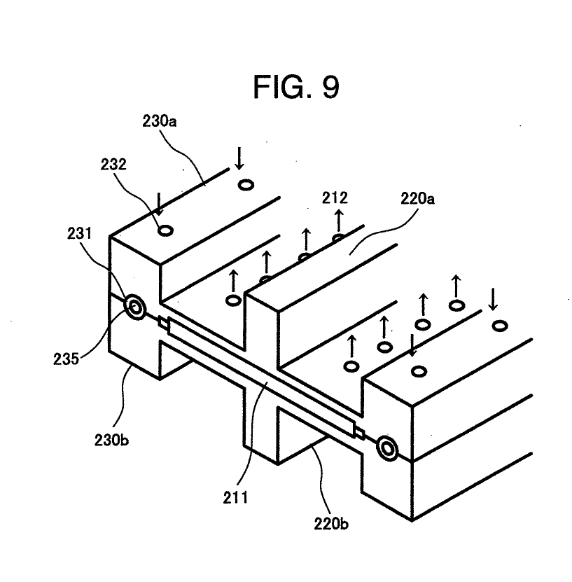

FIG. 9 shows an assembling work when the spacer 214 for spacing the permanent magnets 211 and 241 by the constant distance therebetween is inserted and fitted into a hollow formed in the moving member. The permanent magnets may be fitted, or may be fixed by coating the permanent magnet with an adhesive (not shown) and then inserting the spacer 214; or may be fixed by inserting the permanent magnets into the hollowed member and then injecting the adhesive into the hollow. The respective constituent elements may also be fixed not only by using the adhesive but also by means of welding, bolt, pin, rivet or the like.

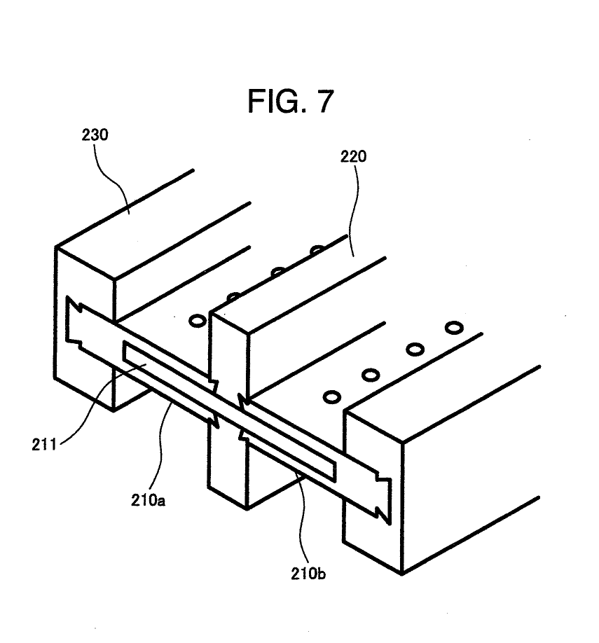

FIG. 7 shows an assembled moving member in a linear motor in accordance with another embodiment of the present invention.

FIG. 7 shows an example of a structure when the moving member is manufactured by dividing the moving member into moving parts 210a and 210b and the moving parts are assembled with projected members 220 and guide rails 230. In this connection, the moving member may be manufactured as a single member without dividing the moving member into the moving parts 210a and 210b, and the moving member may be assembled with the projected members 220 and the guide rails 230.

When the moving member is manufactured in this way, it becomes easy to form holes in the moving parts 210a and 210b and also to form the moving member.

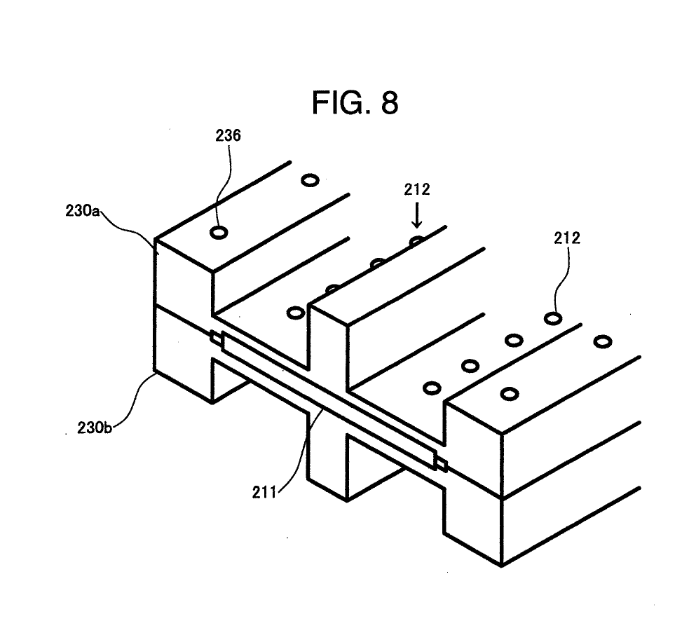

FIG. 8 shows an assembled moving member in a linear motor in accordance with another embodiment of the present invention.

FIG. 8 shows a structure when guide rails having projected parts are divided into, for example, projected upper and lower guide rails 230a and 230b, and the projected guide rails are assembled with the permanent magnets 211, so that the permanent magnets are disposed between the projected guide rails at their middle location.

With such an arrangement as mentioned above, it becomes easy to make holes in the guide rails, and also to form the entire members of the moving member.

FIG. 9 shows an assembled structure of a moving member in a linear motor in accordance with another embodiment of the present invention.

FIG. 9 shows the structure when holes 231 are provided in a guide rail 230 along its longitudinal direction and members 235 having a strong tension are inserted into the holes. When such a permanent magnet part as shown in FIG. 2 are formed to be elongated, fixed to the ground, and the core part is reciprocatedly driven; a linear motor of a stable structure is obtained by providing such members 235 having a strong tension as shown in FIG. 9 in the guide rail 230.

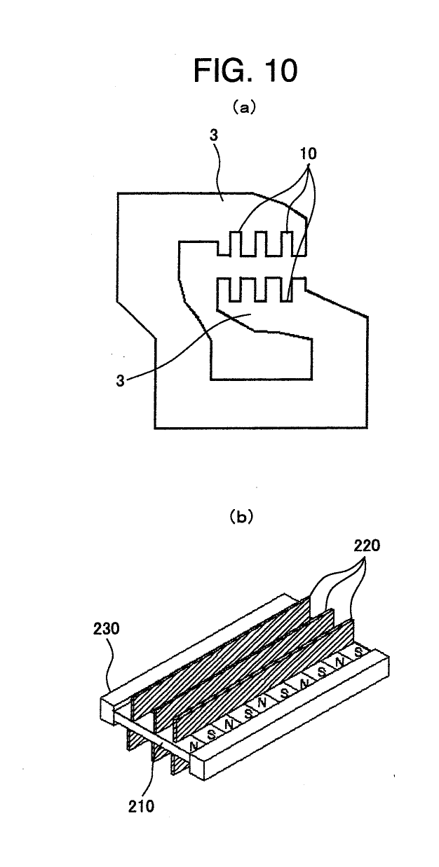

FIG. 10 shows a core and a moving member in a linear motor in accordance with another embodiment.

FIG. 10(a) shows an example when a plurality of slit grooves 10 are formed in the surfaces of armature teeth 3 of a ring-shaped core opposed to both of front and rear surfaces of permanent magnets of the moving member 210 with an air gap defined therebetween (3 slit grooves in the upper surfaces and 3 slit grooves in the lower surface, that is, a total of 6 slit grooves in FIG. 10). FIG. 10(b) shows an example when a plurality of the projected members 220 corresponding in shape to the armature teeth are provided on both of the front and rear surfaces of the moving member 210. With such an arrangement, the rigidity of the moving member as the secondary side member can be increased.

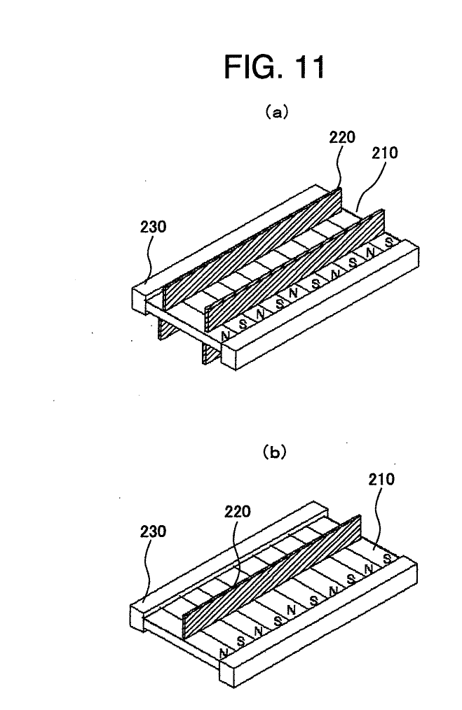

FIG. 11 shows moving members of linear motors in accordance with other embodiments of the present invention.

FIG. 11(a) shows a structure of the linear motor when a plurality of (two in this case) projected members are provided on both of the front and rear surfaces of the moving member 210 at locations slightly offset from the midpoint of the moving member. Even with this arrangement, the rigidity of the moving member can be increased.

FIG. 11(b) shows a structure of the linear motor a single projected member is provided only on one of the both front and rear surfaces of the moving member 210 along its longitudinal direction. Even with this arrangement, the rigidity of the moving member can be increased.

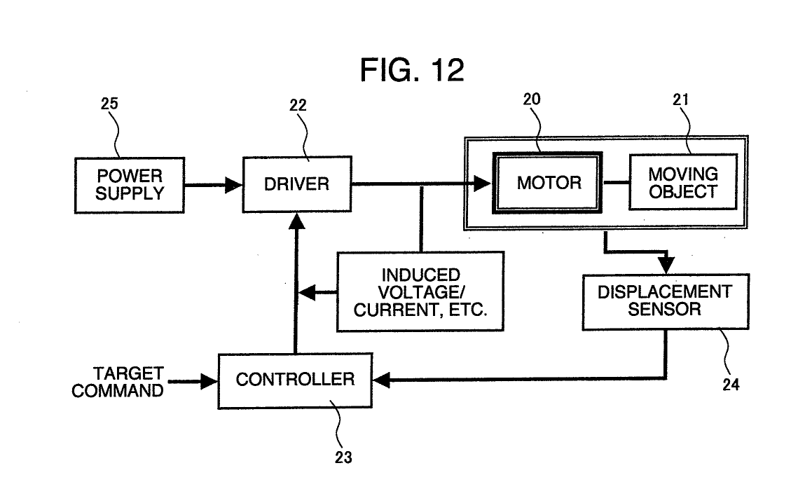

FIG. 12 shows an arrangement of a servo control system using the linear motor of the present invention.

In this system, a linear motor 20 of the present invention is coupled to a moving object 21. The system also includes a driver 22, a controller 23 and a displacement sensor 24. The system is driven according to a target command. Although the system is illustrated as a closed loop control type using the displacement sensor 24 in FIG. 12, an open loop control type without using the displacement sensor may be employed for the system depending on its application. The system also can employ an accurate, high-performance servo control type using a current sensor, magnetic polarity detecting sensor or the like (not shown).

In FIG. 12, with respect to the displacement sensor 24, as in the prior art linear motor, an encoder scale (not shown) is provided along the longitudinal direction of the moving member 210, an encoder detector (not shown) is provided at a location opposed to the encoder scale, and the encoder detector is used as a linear driving device.

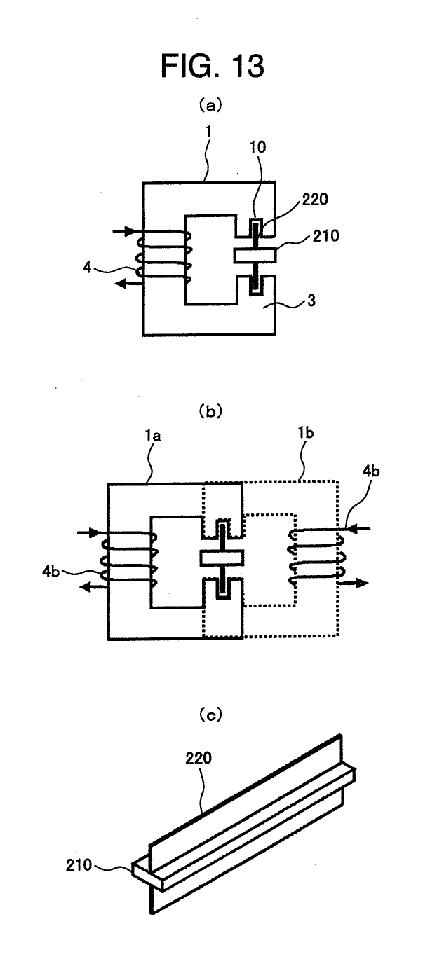

FIG. 13 shows cores and moving members in linear motors in accordance with other embodiments of the present invention.

FIG. 13(a) shows a structure when the projected members 220 of the moving member 210 are provided to be moved along the slit grooves 10 in the armature teeth 3 of the ring-shaped core 1 of a substantially-C-shape. FIG. 13(b) shows a structure when an armature winding 4a is wound around the odd-numbered ring-shaped core la and an armature winding 4b is wound around the even-numbered ring-shaped core 1b. FIG. 13(c) shows a structure when the projected members 220 are provided to the moving member 210 of the aforementioned structure.

In the linear motor of the present invention mentioned above, explanation has been made in connection with the examples when the core has a ring shape and the armature windings are located to the armature teeth. However, an arrangement corresponding to a combination thereof may be employed.

In the foregoing linear motors of the embodiments of the present invention, further, explanation has been made in connection with the example when the permanent magnets are provided to the moving member, and the armature windings are provided to the stator. On the contrary to the above case, however, the armature windings may be provided to the moving member and the permanent magnets may be provided to the stator.

In addition to the embodiments of the aforementioned combinations, such an embodiment as to employ only part of the combinations may be employed. The constituent elements of the linear motors shown in the drawings may be combined among the drawings regardless of the respective embodiments of the drawings, and such combinations may also be molded.

### INDUSTRIAL APPLICABILITY

As has been explained in the foregoing, in accordance with the present invention, when the method of arranging the armature winding is devised, there is provided such a linear motor that a magnetic attracting force between the stator and the moving member can be canceled with a compact structure. Further, a linear motor having a high rigidity using permanent magnets can be provided. In addition, such a support mechanism as to keep an air gap constant using a gas or a liquid can be attained.

1. A linear motor comprising:
a plurality of permanent magnets arranged along a proceeding direction; and
a core opposed to both of front and rear surfaces of the permanent magnets to form a closed magnetic circuit, wherein
a slit groove is formed in each of armature teeth of the core, a projected member movable along the slit groove is provided, a member having the plurality of permanent magnets has holes for allowing a medium to enter or exit.

2. The linear motor according to claim 1, wherein a gas as the medium enters or exist the holes.

3. The linear motor according to claim 1, wherein a liquid as the medium enters or exist the holes.

4. The linear motor according to claim 1, wherein the projected member has holes for allowing the medium to enter or exist.

5. The linear motor according to claim 1, wherein the member having the permanent magnets arrangeable to be spaced by a constant interval is integrally formed with the projected member, and the member has holes for the medium to enter or exist.

6. The linear motor according to claim 1, wherein the stator is supported to be fixed and the moving member is moved.

7. The linear motor according to claim 1, wherein the moving member is supported to be fixed and the stator is moved

8. A linear motor comprising:
a plurality of magnetic materials arranged along a proceeding direction; and
a core opposed to both of front and rear surfaces of the magnetic materials to form a closed magnetic circuit, wherein
a member having the plurality of permanent magnets has holes for allowing a medium to enter or exit.

9. The linear motor according to claim 8, wherein a gas as the medium enters or exits the holes.

10. The linear motor according to claim 8, wherein a liquid as the medium enters or exits the holes.

11. The linear motor according to claim 8, wherein a slit groove is formed in each of armature teeth of the core, and a projected member movable along the slit groove is provided.

12. The linear motor according to claim 11, wherein the projected member has holes for allowing the medium to enter or exit.
